(19) United States
(12) Patent Application Publication
(10) Pub. No.: US 2007/0141295 A1
(43) Pub. Date: Jun. 21, 2007

(54) Optical disc

(76) Inventors: Fung-Hsu Wu, Gueishan Township (TW); Chen Peng, Taipei City (TW); Ping-Hong Lin, Jhongli City (TW)

Correspondence Address: HOFFMAN WARNICK & D'ALESSANDRO, LLC, 75 STATE STREET, 14TH FLOOR, ALBANY, NY, 12207, US

(21) Appl. No.: 11/418,164

(22) Filed: May 4, 2006

(30) Foreign Application Priority Data
Dec. 21, 2005 (TW) 094145481

(51) Int. Cl. B32B 3/02

(52) U.S. Cl. 428/64.4

(57) ABSTRACT

The present invention provides an optical disc which includes a substrate, a groove, a first recordable material layer, a reflective layer, a second recordable material layer, a protective layer, and a label layer. The groove is formed on a surface of the substrate. The reflective layer is formed over the first recordable material layer which is formed over the groove. Moreover, the protective layer is formed over the second recordable material layer while the second recordable material layer is formed over the reflective layer. Finally, the label layer is formed over the protective layer such that an area of the protective layer is exposed. The label layer thereon is used to form an image by the use of an optical pickup unit. More particularly, the second recordable material layer, below the exposed area of the protective layer, is used to record or read the information relative to the image on the second recordable material layer.

### BACKGROUND OF THE INVENTION

1. Field of the Invention

The invention relates to an optical disc and, more particularly, to an optical disc capable of forming an image on its label layer by means of a laser beam.

2. Description of the Prior Art

As it is more and more popular to use optical discs to store data, a problem that follows is how to manage the optical discs in which data has been stored. Because consumers expect to identify the data recorded in their own optical discs with more effective ways, methods to label the non-data side of the optical discs are continuously developed in various forms, such as in text and figures. The basic methods for labeling an optical disc include writing down something on the label side of the optical disc with a permanent marker, such as a sharpie marker, or printing out a paper sticker label and sticking it on the non-data side of the optical disc. Other conventional labeling methods performed in an optical disc player include using ink jet (referring to what is disclosed by Compulog Corporation, in U.S. Pat. No. 6,074,031), thermal wax transfer, thermal dye transfer, and so forth.

A critical problem of automatically labeling an optical disc is that the label side (non-data side) of the optical disc has neither aforementioned pregrooves nor predetermined address codes, such as ATIP codes, so that it is difficult to label marks on the label side of the optical disc.

In recent years, several techniques related to creating patterns on the label layer of an optical disc have been proposed, such as a technique known as the LightScribe technique and disclosed in U.S. Pat. No. 6,864,907 by Hewlett-Packard Development Company, L.P. The technique is to provide an optical disc with a label side having a color that changes in response to radiation or heat. Moreover, the label side is disposed to face an optical pickup, from which a laser beam is emitted to make the label side change its color to form a visible image, which is the information to identify the optical disc. A group of alignment marks are previously pre-printed on the label side in order to position the image to be printed.

However, owing to the characteristics of the material of the label side, so far there is no available method for an optical pickup unit to determine which location on the label side of the optical disc is marked. When images are repeatedly printed on the label side of the optical disc, new images will unavoidably cover previously recorded images. In addition, because the number of alignment marks on the label side is limited, the optical information recording/reproducing apparatus spends more time to position the alignment marks when forming images on the label side, thus extending the time for forming images.

### SUMMARY OF THE INVENTION

An objective of this invention is to provide an optical disc capable of forming an image on its label side by means of a laser beam and maintaining the usage status of its label side. When images are repeatedly printed on the label side of the optical disc, the optical disc can keep a new image from covering a previously recorded image. In addition, the optical disc can effectively shorten the positioning time of the optical pickup unit, thus improving the efficiency of forming an image on the label side

According to a preferred embodiment of the invention, an optical disc includes a substrate, a groove, a first recordable material layer, a reflective layer, a second recordable material layer, a protective layer, and a label layer. The groove is formed on a surface of the substrate and has a plurality of position marks therein. The first recordable material layer is formed over the surface of the substrate and over the groove. In addition, the reflective layer is formed over the first recordable material layer.

Furthermore, the second recordable material layer is formed over the reflective layer. The protective layer is also formed over the second recordable material. In addition, the label layer is formed over the protective layer such that an area of the protective layer is exposed. The label layer is used for forming an image by the use of an optical pickup unit.

Most importantly, the aforementioned second recordable material layer, below the exposed area of the protective layer, is used to record or read information relative to the image thereon by using the optical pickup unit. Moreover, the plurality of position marks are used to provide the optical pickup unit with a basis for recording or reading the information relative to the image on the second recordable material layer.

The advantage and spirit of the invention may be understood by the following recitations together with the appended drawings.

### BRIEF DESCRIPTION OF THE APPENDED DRAWINGS

FIG. 1A is a figure illustrating an optical disc according to a preferred embodiment of the invention.

FIG. 1B is a cross-sectional view along the M-M line in FIG. 1A.

### DETAILED DESCRIPTION OF THE INVENTION

The invention is to provide an optical disc and, more particularly, an optical disc showing its status in maintenance by means of an indicating material. Some embodiments and practical applications of this invention are clearly recited below to fully explain the characteristic, spirit, and advantage of this invention.

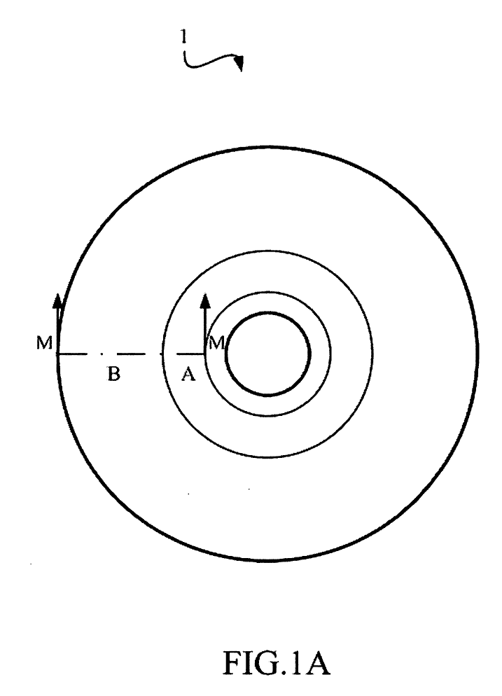

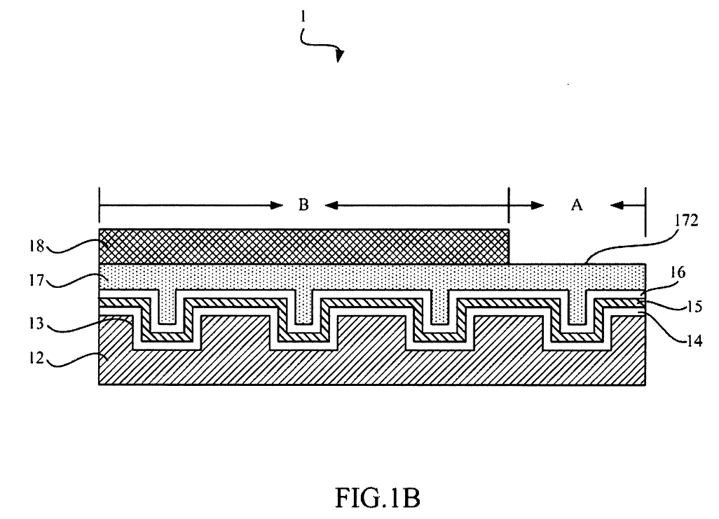

Referring to FIG. 1A and FIG. 1B, FIG. 1A is a figure illustrating an optical disc 1 according to an embodiment of the invention, and FIG. 1B is a cross-sectional view along the M-M line in FIG. 1A. The optical disc includes a substrate 12, a groove 13, a first recordable material layer 14, a reflective layer 15, a second recording material layer 16, a protective layer 17, and a label layer 18.

The groove 13 is formed on a surface of the substrate 12, and a plurality of position marks (not illustrated in the figures) are also configured in the groove. The first recordable material layer 14 is formed over the surface of the substrate 12 and over the groove 13. In addition, the reflective layer 15 is formed over the first recordable material layer 14. In practical applications, the first recordable material layer 14 is used for recording or reading a data thereon by an optical pickup unit, and the first recordable material layer 14 is formed from a dye material or a phase change material.

Furthermore, the second recordable material layer 16 is formed over the reflective layer 15, and the protective layer 17 is formed over the second recordable material layer 16. Moreover, the label layer 18 is formed over the protective layer 17, such that an area 172 of the protective layer 17 is exposed. The label layer 18 is used for forming an image thereon by using the optical pickup unit. In practical applications, the second recordable material layer 16 is formed from a dye material or a phase change material.

Most importantly, as mentioned above, the second recordable material layer 16, below the exposed area A of the protective layer 17, is used for recording or reading information relative to the image thereon by using the optical pickup unit. The plurality of position marks are used to provide the optical pickup unit with a basis for recording or reading the information relative to the image on the second recordable material layer 16. In addition, the plurality of position marks also provide the optical pickup unit with a basis for recording or reading the data on the first recordable material layer 14.

In practice, the plurality of position marks are ATIP codes, which are stated in the book, “Compact Disc Recordable System Description” (Third Edition). When the optical pickup unit is instructed to form the image on the label layer, the plurality of position marks simplify the process of positioning the label layer as they are read to register a specified position on the label layer.

In addition, in this embodiment, the exposed area 172 of the protective layer 17 is located on an inner annular region A of the substrate. On the other hand, in another embodiment, the exposed area 172 of the protective layer 17 is located on an outer annular region of the substrate.

In an embodiment, the label layer has a color which changes in response to radiation or heat of a laser beam emitted by the optical pickup unit to form the image. According to an embodiment of this invention, an optical disc is configured to comply with DVD-R specification, DVD+R specification, DVD-RW specification, a CD-R specification, or a CD-RW specification.

Obviously, the optical disc can maintain the usage status by means of the aforementioned second recordable material layer, and it can also keep a new image from covering a previously recorded image when images are repeatedly printed on the label side of the optical disc. Moreover, for the optical pickup unit, the plurality of position marks can simplify the process of positioning the label layer and prominently improve the speed of forming the image on the label layer.

Although the preferred embodiments of the invention are already disclosed above, the scope of the invention is not restricted by the preferred embodiments. Anyone familiar with this art can do alteration and modification as long as he complies with the spirit and scope of this invention. Therefore, what is claimed below is a standard followed by the protected scope of the invention.

What is claimed is:

1. An optical disc, comprising:
a substrate;
a groove formed on a surface of the substrate, said groove having a plurality of position marks therein;
a first recordable material layer formed over the surface of the substrate and over the groove;
a reflective layer formed over the first recordable material layer;
a second recordable material layer formed over the reflective layer;
a protective layer formed over the second recordable material; and
a label layer formed over the protective layer such that an area of the protective layer is exposed, said label layer thereon being used to form an image by the use of an optical pickup unit;
wherein the second recordable material layer, below the exposed area of the protective layer, is used to record or read information relative to the image thereon by the use of the optical pickup unit, and the plurality of position marks are used to provide the optical pickup unit with a basis for recording or reading the information relative to the image on the second recordable material layer.

2. The optical disc of claim 1, wherein the first recordable material layer is formed from a dye material or a phase change material.

3. The optical disc of claim 1, wherein the second recordable material layer is formed from a dye material or a phase change material.

4. The optical disc of claim 1, wherein the label layer has a color which changes in response to radiation or heat of a laser beam emitted by the optical pickup unit to form the image.

5. The optical disc of claim 1, wherein the first recordable material layer is used to record or read data thereon by use of the optical pickup unit, the plurality of position marks are used to provide the optical pickup unit with a basis for recording or reading the data from the first recordable material layer.

6. The optical disc of claim 1, wherein the optical disc is configured to comply with a DVD-R specification, a DVD+R specification, or a DVD-RW specification.

7. The optical disc of claim 1, wherein the optical disc is configured to comply with a CD-R specification or a CD-RW specification.

8. The optical disc of claim 1, wherein the exposed area of the protective layer is located in an inner annular region of the substrate.

9. The optical disc of claim 1, wherein the exposed area of the protective layer is located in an outer annular region of the substrate.
